(19) United States
(12) Patent Application Publication
(10) Pub. No.: US 2006/0263107 A1
(43) Pub. Date: Nov. 23, 2006

(54) Image forming device capable of displaying total remaining amount of developing agent in monochrome printing mode

(75) Inventors: Hideaki Inukai, Nagano-ken (JP); Kazuyoshi Utsumi, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/487,535

(22) Filed: Jul. 17, 2006

Related U.S. Application Data
(63) Continuation of application No. PCT/JP05/00369, filed on Jan. 14, 2005.

(30) Foreign Application Priority Data
Jan. 16, 2004 (JP) 2004-9036

(51) Int. Cl. G03G 15/01; G03G 15/08

(52) U.S. Cl. 399/27; 399/227

(57) ABSTRACT

An image forming device has an image carrier (20) and a development device (50) in which development units (51-54) are detachably attached, and the development units has a memory for storing color information and remaining amount information of development agent. The image forming device operates as a monochrome printing mode when single color development units are attached at attachment positions of the development device, further has a display unit (95) for displaying a remaining amount of developing agent in the development units, and a control unit for obtaining an initial total amount of developing agent in an initial state and a current total remaining amount of developing agent of attached development units, and for displaying on the display unit the initial total amount and the total remaining amount. By displaying the initial and current total amount of development units, the convenience of replacement administration of development units can be improved.

### CROSS REFERENCE TO RELATED APPLICATIONS

This application is a continuation of International Application No. PCT/JP2005/000369, filed on Jan. 14, 2005, now pending, herein incorporated by reference. Further, this application is based upon and claims the benefit of priority from the prior. Japanese Patent Application No. 2004-9036, filed on Jan. 16, 2004, the entire contents of which are incorporated herein by reference.

### TECHNICAL FIELD

The present invention relates to image forming devices such as color printers, facsimile machines, and copier machines that form images using electrophotographic techniques and more particularly relates to image forming devices having improved flexibility of administrating development units in monochrome printing mode.

### BACKGROUND ART

Image forming device, provided in color printers or the like, that forms images using electrophotographic techniques are provided with an image carrier on which an electrostatic latent image is formed corresponding to image data, a charging unit that charges an outer surface of the image carrier, an exposure unit that exposes the charged outer surface of the image carrier according to the image data to form the electrostatic latent image, a development device that supplies toner, which is a developing agent, to the electrostatic latent image to develop a toner image, and a transfer unit for transferring the toner image to a medium targeted for transfer. The development device detachably supports development units containing a plurality of color toners and is provided with a development unit support body that makes the appropriate development unit approach the image carrier in accordance with a timing for development. The development unit support body is ordinarily a development rotary that is rotationally controlled. When carrying out color printing, the development units of color toners of a plurality of colors, for example four colors (yellow Y, magenta M, cyan C, and black K) are attached to the development rotary. Furthermore, when carrying out monochrome printing, for example black and white printing, the development unit of black is attached to the development rotary.

This image forming device can be put in color printing mode by attaching the development units of four colors and can be put in monochrome printing mode by attaching only the black development unit, and it has been proposed to make both modes switchable as appropriate by a user. For example, see patent documents: 1. Japanese Patent Application Laid-open No. 2003-43773 (Laid open on Feb. 14, 2003); 2. Japanese Patent Application Laid-open No. 2002-351190 (Laid open on Dec. 4, 2002); and 3. Request for Patent No. 2003-1600591.

In patent documents 1 and 3, image forming devices are disclosed in which the color printing mode is set when the development units of the four colors are attached to the development rotary and the monochrome printing mode is set when the black development unit is attached at only the attachment position of the black development unit of the development rotary and development units are not attached in the other CMY attachment positions.

Furthermore, in patent document 2, an image forming device is disclosed in which a black development unit is attachable in arbitrary attachment positions on the development rotary. With this image forming device, the development unit of which color is attached in which position on the development rotary is detected by reading information of the color of the developing agent from a memory arranged at the development unit and rotational control of the development rotary in the development process is carried out based on the detected positions. Specifically, it is described in patent document 2 that operation is performed as a color printer when the development units of the four colors CMYK are attached and operation is performed as a black monochrome printer when only the black development unit is attached. It is described that the black development unit can be attached in an arbitrary number of locations 1 to 4 such that the frequency of replacing development units can be suppressed when a plurality of black development units is attached.

Further still, an image forming device is proposed in which the number of times of replacing development units can be reduced by attaching black development units in all of the four attachment positions of the development rotary, thereby using monochrome printing mode. For example, see patent document: 4. Japanese Patent Application Laid-open No. 2003-316106 (Laid open on Nov. 6, 2003). With the image forming device, the replacement frequency of development units in monochrome printing mode can be suppressed, even in development device that has been made compact, by attaching black development units in all the four attachment positions of a development rotary for color printing, detecting attachment information, color information, and the amount of toner remaining by reading out memories arranged in the development units, and using the black development units in order.

### DISCLOSURE OF THE INVENTION

The image forming devices of patent documents 1 and 3 operate in color printing mode when the development units of the four colors (CMYK) are attached to the development rotary and operate in monochrome printing mode only when the black development unit is attached at the black position of the development rotary. Accordingly, in order to achieve monochrome printing mode, the black development unit can be attached in only the black position and the black development unit is not permitted to be attached in the other positions such that there are problems of having no flexibility or freedom in the attachment position of the black development unit and user convenience is reduced.

On the other hand, in the monochrome printing mode of the image forming device of patent document 2, the development unit of black or any other single color is permitted to be attached in an arbitrary position of the four locations of development unit attachment positions. However, there is no mention concerning a method for displaying the amount of toner remaining when a plurality of same color development units is attached and no mention concerning in which manner display can be conducted so that user convenience can be improved.

Further still, in the image forming device of patent document 4 also, although four black development units are permitted to be attached in the four attachment positions, there is no mention of a display method concerning how to notify the user in this case of the amount of toner remaining.

Along with improving the level of freedom of development unit attachment in monochrome printing, how to carry out display to the user the amount of toner remaining in the attached development units is essential to improving user convenience.

Accordingly, the object of the present invention is to provide an image forming device in which an arbitrary number of same color development units is attached to operate in monochrome printing mode and that is capable of displaying the remaining amount of developing agent such that convenience to the user for controlling development units such as in adding or replacing development units is improved.

In order to achieve the above-mentioned object, a first aspect of the present invention is an image forming device comprising an image carrier on which a latent image is formed, and a development device in which a plurality of development units housing developing agent are detachably attached, wherein the image forming device

operates in a monochrome printing mode when an arbitrary number of same color development units are attached at a plurality of attachment positions of the development device, further comprises display means for displaying a remaining amount of developing agent in the development units, and

control means for obtaining an initial total amount of developing agent in an initial state and a current total remaining amount of developing agent of the attached development units, and for displaying on the display means information of the initial total amount and information of the total remaining amount.

In the aforementioned first aspect, a preferable embodiment is that information of the total remaining amount is remaining amount information that indicates a proportion of the total remaining amount with respect to the initial total amount.

In the aforementioned first aspect, another preferable embodiment is that the control means displays, on the display means, an outer frame display of a size corresponding to the initial total amount and a remaining amount display of a size corresponding to the total remaining amount in parallel.

In the aforementioned first aspect, another preferable embodiment is that the control means displays, on the display means, a character display corresponding to the initial total amount and a remaining amount display indicating a proportion of the total remaining amount with respect to the initial total amount in parallel.

In order to achieve the above-mentioned object, a second aspect of the present invention is an image forming device comprising an image carrier on which a latent image is formed, and a development device in which a plurality of development units that house developing agent are detachably attached, and being able to communicate with a host computer, wherein the image forming device, operates in a monochrome printing mode when an arbitrary number of same color development units are attached at a plurality of attachment positions of the development device, and obtains an initial total amount of developing agent in an initial state and a current total remaining amount of developing agent of the attached plurality of development units, and outputs as appropriate to the host computer data of information of the initial total amount and information of the total remaining amount, and displays information of the initial total amount and information of the total remaining amount on the host computer.

According to the above-described first and second aspects, in the monochrome printing mode in which a plurality of single color, that is, same single color development units are attached, an initial total amount of developing agent in an initial state of a plurality of attached development units and a current remaining total amount of developing agent are displayed, and therefore using this display the user can easily recognize the remaining total amount with respect to the total amount of the initial state, and the convenience of controlling such factors as replacements and additions of development units in monochrome printing mode can be improved. For example, the display of the initial total amount and the remaining total amount in the present invention is effective in the case of use as a monochrome image forming device by attaching a plurality of black development units.

### BRIEF DESCRIPTION OF THE DRAWINGS

FIG. 1 is a principle structural view of an image forming device according to the present embodiment (when in color printing mode).

FIG. 2 is a principle structural view of the image forming device according to the present embodiment (when in monochrome printing mode).

FIG. 3 is a principle structural view of the image forming device according to the present embodiment (when in monochrome printing mode).

FIG. 4 is a principle structural view of the image forming device according to the present embodiment (when in monochrome printing mode).

FIG. 5 is a structural view of a control unit 100 according to the present embodiment.

FIG. 6A illustrates a rotation operation of a development device.

FIG. 6B illustrates a rotation operation of the development device.

FIG. 6C illustrates a rotation operation of the development device.

FIGS. 7A through 7D illustrate a coupling means of the development device and the development units.

FIG. 8 is a flowchart showing a printing mode determination operation according to the present embodiment.

FIG. 9 shows a determination table involved in the printing mode determination.

FIG. 10 is a flowchart showing an operation of controlling display of an amount of remaining toner.

FIGS. 11A through 11 D illustrate development unit attachment conditions and examples of display on the display panel in black monochrome printing mode.

FIGS. 12E through 12H illustrate development unit attachment conditions and examples of display on the display panel in color printing mode and black monochrome printing mode.

FIG. 13 illustrates examples of displaying the amount of remaining toner in the development units by a printer driver of a host computer.

### BEST MODE FOR CARRYING OUT THE INVENTION

The following is a description of embodiments of the present invention with reference to the accompanying drawings. However, the technical scope of the present invention is not limited to these embodiments and extends to articles described in the scope of the claims and equivalents thereof.

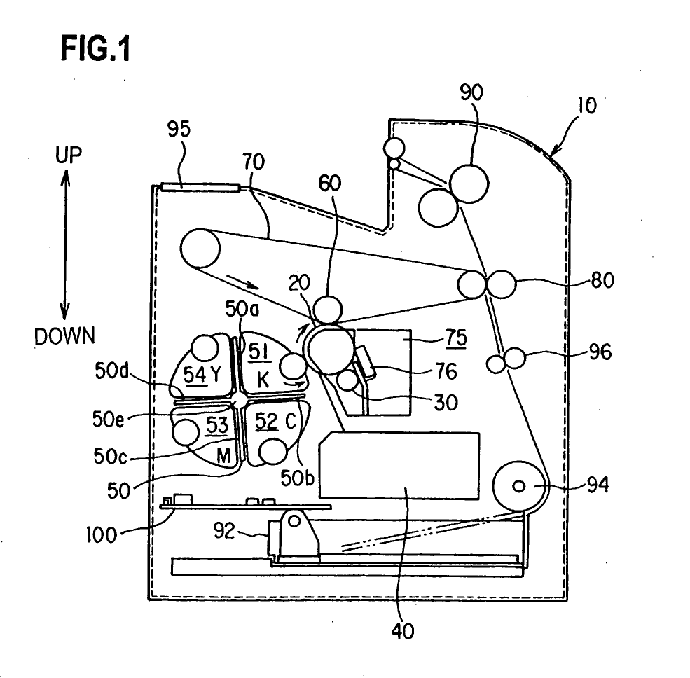

FIG. 1 is a principle structural view of an image forming device according to the present embodiment. The present embodiment is described using a laser beam printer 10 as an example of an image forming device. The printer 10 in FIG. 1 shows a configuration of when in a color printing mode.

Along a rotation direction of a photosensitive drum 20, which is an image carrier that carries a latent image, the printer 10 is provided with a charging unit 30, an exposure unit 40, a development device 50, a primary transfer unit 60, an intermediate transfer body 70, and a cleaning unit 75. Further still, the printer 10 is provided with a secondary transfer unit 80, a fixing unit 90, a display unit 95 that outputs various information to a user, and a control unit 100 that controls these units.

The photosensitive drum 20 is provided with a cylindrical conductive substrate and a photosensitive layer formed on an outer surface thereof, is rotatable on a central axis, and rotates clockwise as shown by the arrow. The charging unit 30 charges the photosensitive drum 20 and the exposure unit 40 irradiates a beam onto the charged photosensitive drum 20 from a light source such as an internally mounted laser or an LED array to form a latent image using static electricity. The beam irradiation of the exposure unit 40 is controlled by a modulated drive signal according to image information that is inputted from a host computer.

The development device 50 has attachment positions 50a to 50d at which development units 51 to 54, containing the developing agent toner are detachably attached and is a development rotary that is rotatable on a central axis 50e. By rotating the development device 50 to cause the required development units 51 to 54 to approach the photosensitive drum 20 and supplying the developing agent to the photosensitive drum 20 on which the latent image is formed, the latent image is developed into an image by the developing agent. In the example shown in FIG. 1, the development units 51 to 54 containing developing agents of black K, cyan C, magenta M, and yellow Y respectively are attached in the attachment positions 50a to 50d of the development device 50 in color printing mode and the formation of latent images on the photosensitive drum 20 and the development of these using the development agents are carried out in the order CMYK in the printing process. Accordingly, for each process of latent image formation and development of each color, the development device 50 rotates clockwise to make the development unit of the appropriate color approach the photosensitive drum 20 and carry out development successively.

The primary transfer unit 60 transfers the toner image formed on the photosensitive drum 20 to the intermediate transfer body 70. The intermediate transfer body 70 is an endless belt on which for example an aluminum deposition layer is formed on a surface of PET film with a semiconductive coating formed on that surface and is rotationally driven at the same peripheral velocity as the photosensitive drum 20. For color printing jobs, the respective CMYK images are superimposed and transferred to the intermediate transfer body 70 and for monochrome printing jobs, an image of a single color is transferred to the intermediate transfer body 70. The secondary transfer unit 80 then transfers the toner image that is formed on the intermediate transfer body 70 to a printing medium such as paper, and the fixing unit 90 makes this a permanent image by making the toner image that has been transferred onto the printing medium adhere to the medium, and this printing medium is discharged out of the printer.

The cleaning unit 75 is arranged between the primary transfer unit 60 and the charging unit 30, is provided with a cleaning blade 76 that contacts the surface of the photosensitive drum 20, and uses the cleaning blade 76 to remove the developing agent (toner) that remains on the photosensitive drum 20 after primary transfer.

The development units 51 to 54 can be attached to and detached from the development device 50 and a storage medium, for example a non-contact, nonvolatile memory, is provided in the development units for storing color information and remaining amount information of the developing agent so that the printer can recognize the condition of the development units that are attached. Then, after the power is turned on and after the development unit(s) are attached to the development device, the information in the nonvolatile memory of the development unit(s) is read out. Furthermore, after development, the information of the remaining amount of developing agent is updated in the nonvolatile memory of the development unit.

When the CMYK development units 51 to 54 are attached in the development device 50 in their respective predetermined positions, the printer 10 recognizes the condition of attachment thereof by reading out information from the aforementioned nonvolatile memory and operates in color printing mode. In color printing mode, print job data described in a language for color printing is supplied from the host computer, and the formation of an electrostatic latent image on the photosensitive drum 20, development by the corresponding color development unit, and the transfer of the toner image to the intermediate transfer body 70 by the primary transfer unit 60 are repeated in the order CMYK. Then, after the CMYK toner images have been transferred to the intermediate transfer body 70, the color image on the intermediate transfer body is transferred to the printing medium such as paper by the secondary transfer unit 80, fixed by the fixing unit 90, and discharged out of the printer.

Furthermore, when print job data from the host computer indicating monochrome printing is supplied when the CMYK development units are attached as in FIG. 1, development is carried out by the indicated monochrome, for example black, development unit and a monochrome image is formed on the printing medium.

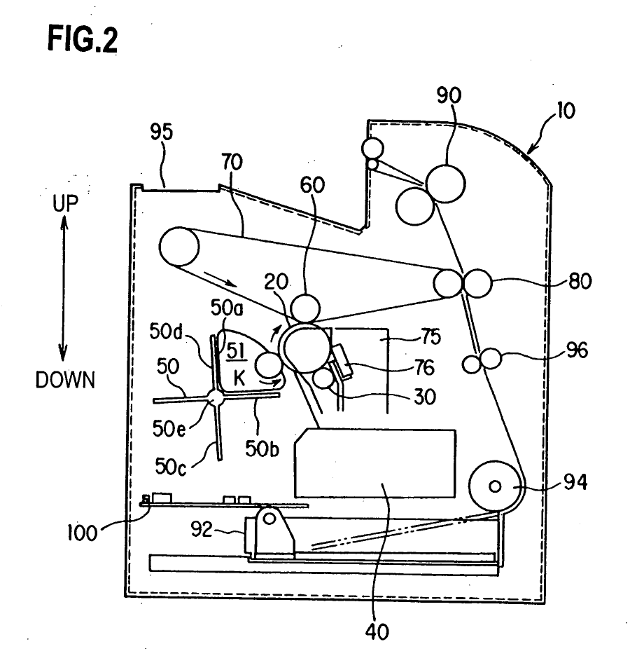

FIGS. 2 to 4 are principle structural views of the image forming device of the present embodiment and these diagrams show configurations of a black monochrome printing mode (a printing mode in which the developing agent of only one color is used). In FIGS. 2 to 4, structural portions that are the same as in FIG. 1 are given the same reference number. FIG. 2 is an example in which a black development unit 51 is attached in the development device 50 in only an attachment position 50a for black. Here, the color information of black is read out from the nonvolatile memory arranged in a development unit 51, which is described later, and the fact that the black development unit 51 is attached in the attachment position 50a and the fact that no development unit is attached in the other attachment positions are detected by the control unit 100, thereby detecting the fact of being in monochrome printing mode. When a single development unit for black is attached in an attachment position other than the attachment position 50a for black, the control unit 100 similarly detects that attachment condition and detects the fact of being in monochrome printing mode. Similarly, a development unit of a color other than black is attached, the fact of being in the monochrome printing mode of the color of the attached developing agent is detected. When the fact of being in monochrome printing mode is detected, the mode information thereof is notified to the printer driver of the host computer and in accordance with this, print job data in a language for monochrome printing is supplied from the host computer.

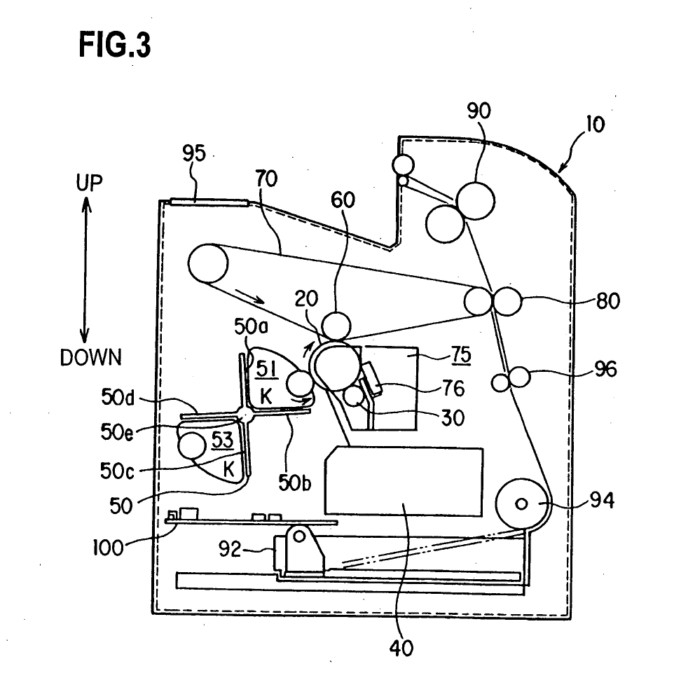

FIG. 3 shows an example in which to the development device 50 the development units 51 and 53 for black are attached in the attachment position 50c for magenta in addition to the attachment position 50a for black. The three color development units for CMY can be attached only in their respective predetermined attachment positions 50b, 50c, and 50d by a physical coupling means that is described later. On the other hand, the development unit for black can be attached in any of the four attachment positions 50a to 50d. And as shown in FIG. 3, when the development units 51 and 53 for black are attached in the attachment position 50a for black and the attachment position 50c for magenta, the color information in the nonvolatile memories arranged in the development units is read out, the attachment condition thereof is detected in the control unit, and the fact of being in black monochrome printing mode is detected.

Since there are two development units 51 and 53 for black attached, the development process is executed with both of the development units being rotationally controlled in the position of the photosensitive drum 20 for monochrome printing. Furthermore, the toner amount remaining information of the nonvolatile memories of the respective development units 51 and 53 is maintained, the amount remaining information is read out, and the amount remaining is displayed on a display panel 95 in an individual amount remaining display mode, in which the presence/absence of development units in the attachment positions 50a to 50d and the toner amount remaining is displayed, or a total remaining amount display mode, in which an aggregate amount remaining of the two black development units is displayed on the display panel & operation panel 95, which is a display means & input means.

The attachment positions of the two development units for black can be in two arbitrary locations and operation in monochrome printing mode is performed using either of these.

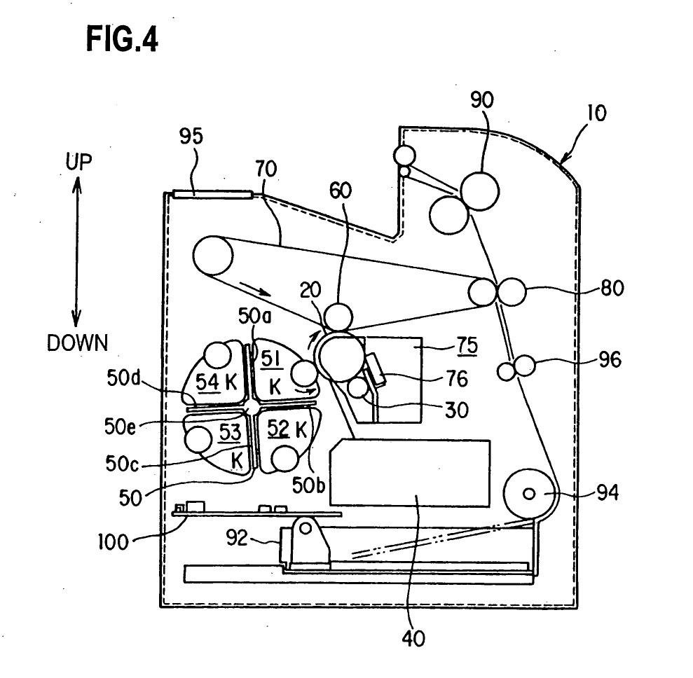

FIG. 4 shows an example in which the development units 51 to 54 for black are attached in all the attachment positions 50. Here too, the color information in the nonvolatile memories of the four development units is read out and monochrome printing mode is determined by the control unit 100. Then, each time the development process is executed, the toner amount remaining information is written to the nonvolatile memory of the development unit that is used and the current toner amount remaining information is maintained. Furthermore, the memory of the attached development unit is read out and total amount information of toner in an initial condition and the current toner amount remaining information are displayed on the display panel 95 in a manner that is described later.

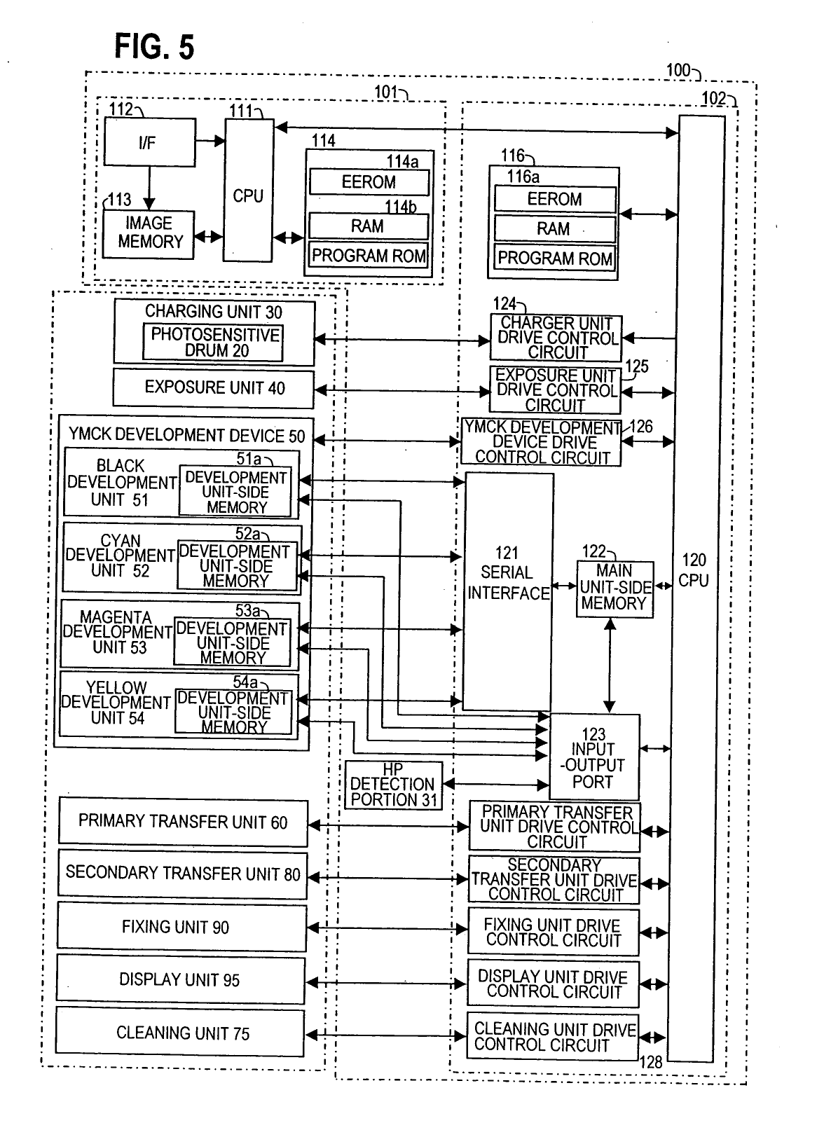

FIG. 5 is a structural view of the control unit 100 of the present embodiment. The control unit 100 is supplied with print job data from the host computer to carry out predetermined image processing and is provided with a main controller 101 that generates an engine control signal and an image signal and carries out display control for the display panel 95, and an engine controller 102 that controls each unit of a printing engine. The main controller 101 is provided with an interface 112 that receives print job data from the host computer, an image memory 113 that stores image data of the print job data, a CPU 111 that carries out image processing such as halftone processing, as well as setting of the display mode, automatic judgment, and display control of the display panel, and a memory unit 114 that has a nonvolatile memory 114a, and a RAM and a ROM 114b.

Print mode information indicating whether the printer is in color printing mode or monochrome printing mode is stored in the nonvolatile memory 114a. The printing mode is determined by the main controller 101 according to information from the development unit(s) attached in the development device when the power is turned on, and information of the print mode that is determined is written to the nonvolatile memory 114a.

In addition to the CPU 120, the engine controller 102 is provided with a main memory unit 116, a serial interface 121, a main unit-side memory 122, an input-output port 123, drive control circuits 124, 125, and 126 that drive the charging unit 30, the exposure unit 40, and the development unit 50, and drive control circuits 128 that control the primary transfer unit 60, the secondary transfer unit 80, the fixing unit 90, the display unit 95, and the cleaning unit 75. Furthermore, a detection portion 31 is arranged that detects a home position of the development device 50.

The engine controller 102 is supplied with a control signal for controlling the printing process from the main controller 101 and an image signal that controls the irradiation of the exposure beam, and carries out control of each unit. Furthermore, the development units 51 to 54 attached to the development device 50 are provided with respective development unit-side memories 51a to 51d. These memories are constituted by a nonvolatile memory such as an FeRAM or an EEPROM for example, and store information such as developing agent color information, information relating to the amount of developing agent in an initial state, current developing agent amount remaining information, development unit ID (identification information) and the like. When these memories are constituted by FeRAMs, non-contact access can be achieved through the serial interface 121 and when constituted by EEPROMs, access can be achieved by physically connecting the serial interface 121. When the power is turned on, or when a development unit is replaced or additionally attached, the engine controller 102 accesses these development unit-side memories 51a to 54a and reads information such as the presence/absence of attachment of development units, color information, information relating to the amount of developing agent in an initial state, current amount remaining information, and identification information. Furthermore, at the time of the development processing, the developing agent amount remaining information in the memory of any unit that has finished develop processing undergoes updating.

The main unit-side memory 122 is constituted by a nonvolatile memory such as an EEPROM for example and stores parameter values and the like for engine control. Information of whether or not a development unit is attached in the four attachment positions of the development device and the above-mentioned information that has been read such as the color information and identification information of the attached development unit are stored in the in the nonvolatile memory 116a inside the memory unit 116. Then, these items of information are conveyed from the CPU 120 inside the engine controller 102 to the CPU 111 inside the main controller 101 and based on these items of information, the CPU 111 carries out determination of the printing mode and control of the display of the amount remaining of developing agent. It should be noted that the color information and the amount remaining information of the developing agent may be held and updated in the main unit-side memory 122 inside the engine controller or the memory unit 114 inside the engine controller. That is, when a development unit is newly attached or replaced, the user may input the attachment position thereof and the color information of that development unit, and each time the main controller 101 generates the image signal for printing, the developing agent amount remaining information of the development unit may be updated by calculation and stored in the aforementioned memory. However, in this case, it is necessary for the user to reset the remaining amount of the replaced development unit when a development unit is replaced.

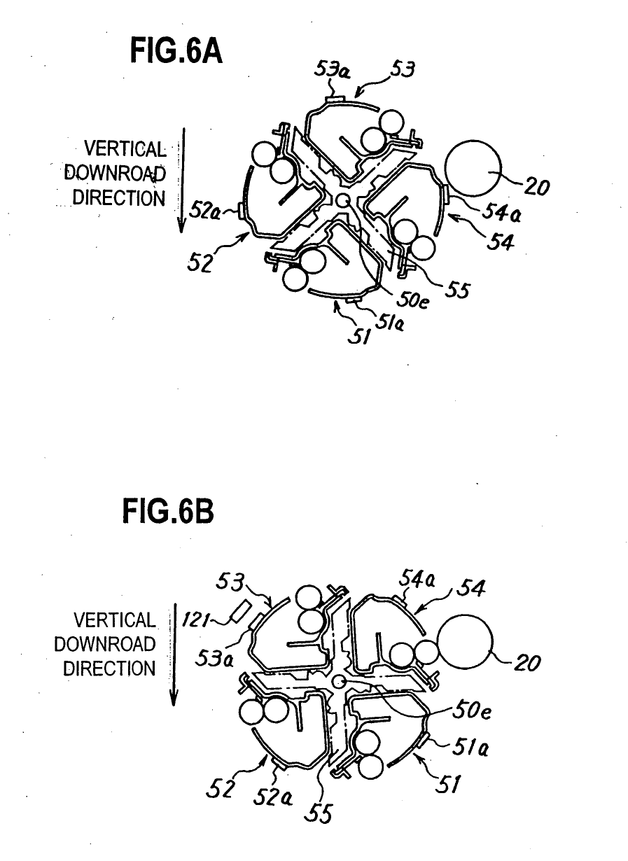

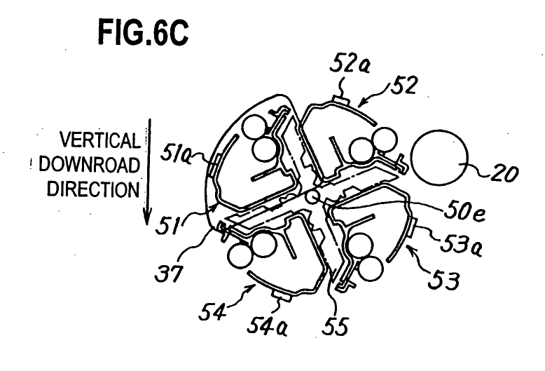

FIG. 6 shows rotation operations of the development device. Three positional relationships between the development device 50, in which the four development units 51 to 54 are attached, and the photosensitive drum 20 are shown in the diagrams of FIG. 6. FIG. 6A shows a home position, FIG. 6B shows a development and memory access position, and FIG. 6C shows an attachment/detachment position of the development units. The development device 50, which is a development rotary, is rotated by an unshown pulse motor centered on the central axis 50e and a support frame 55 (including the attachment positions 50a to 50d) for supporting the development units is fixed to the central axis 50e.

The home position in FIG. 6A is a position detected by the home position detection portion 31 (FIG. 5) and is a reset position for rotation control of the development rotary. At this position, the development units are not in a position aligned with an attachment/detachment hole 37 (FIG. 6C), and therefore replacement of the development units is prevented even if for example the development unit replacement panel is opened.

At the development position in FIG. 6B, the development roller of the development unit 54 is made to approach the photosensitive drum 20 and developing agent of the development unit 54 is supplied to the photosensitive drum 20. Furthermore, at this position, the memory 53a of the development unit 53, which has finished the development process, undergoes non-contact access by the serial interface 121, the information in the memory 53a is read out, and the development unit amount remaining information is updated. Since there is no need to apply a physical force to the development device to achieve access during the development process as long as it is non-contact access, the access that is involved does not exert an influence on the development process.

The attachment/detachment position in FIG. 6C is a position in which rotational control is performed when the development unit replacement panel is opened and a replacement button is pushed and the development unit 51 is replaceable from the replacement hole 37 at this position. For example, the development device 50 is controlled so as to rotate 90° each time the replacement button is pushed and the development units are controlled to successively rotate to the attachment/detachment position. Also, when development unit replacement is selected upon the detection of toner running out, the development device 50 is controlled to rotate in response to the replacement button to the position of the development unit that has run out of toner or to an unattached position. Instead of the above-mentioned replacement button, four attachment position buttons may be provided for the four attachment positions. In this case, when the attachment position button corresponding to the attachment position of the unit to be replaced is pushed, rotational control is performed such that this attachment position becomes the attachment/detachment position.

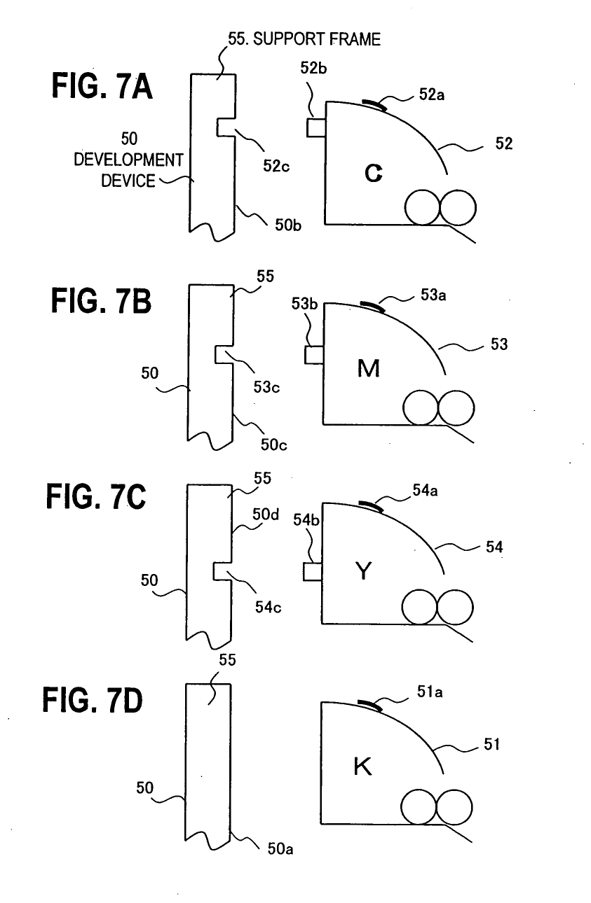

FIG. 7 shows a coupling means of the development device and the development units. FIG. 7A shows a coupling structure of the development unit 52 for cyan and the support frame 55 of the attachment position 50b thereof and is formed such that a convex portion 52b of the development unit 52 and a concave portion 52c of the support frame 55 couple together. FIG. 7B shows a coupling structure of the development unit 53 for magenta and the support frame 55 of the attachment position 50c thereof and FIG. 7C shows a coupling structure of the development unit 54 for yellow and the support frame 55 of the attachment position 50d thereof. In these too, convex portions 53b and 54b are provided on the development unit side and concave portions 53c and 54c are provided on the support frame 55 side, and these couple together in the same manner. Furthermore, FIG. 7D shows a structure the development unit 51 for black and the support frame 55 of the attachment position 50a thereof. No convex portion is formed in the development unit 51 for black and consequently no concave portion is formed in the support frame 55 thereof. Each development unit is inserted or retracted in a direction perpendicular to the paper plane to be attached or withdrawn.

As evident from the coupling means shown in FIG. 7, the CMY development units 52, 53, and 54 are provided with the respective different convex portions 52b, 53b, and 54b, and at the attachment positions 50b, 50c, and 50d where these attach, the concave portions 52c, 53c, and 54c are arranged in positions corresponding to the convex portions such that the CMY development units can be attached by these coupling means in only predetermined positions. Attachment is impossible other than in the predetermined positions. Using such physical coupling means assures that the CMYK development units are attached in a decided order in decided positions for color printing mode, and supports high speed printing and high quality images for color printing. In contrast to this, no convex portion is formed in the development unit 51 for black and therefore attachment is possible in any of the attachment positions 50b, 50c, and 50d in addition to the attachment position 50a for black.

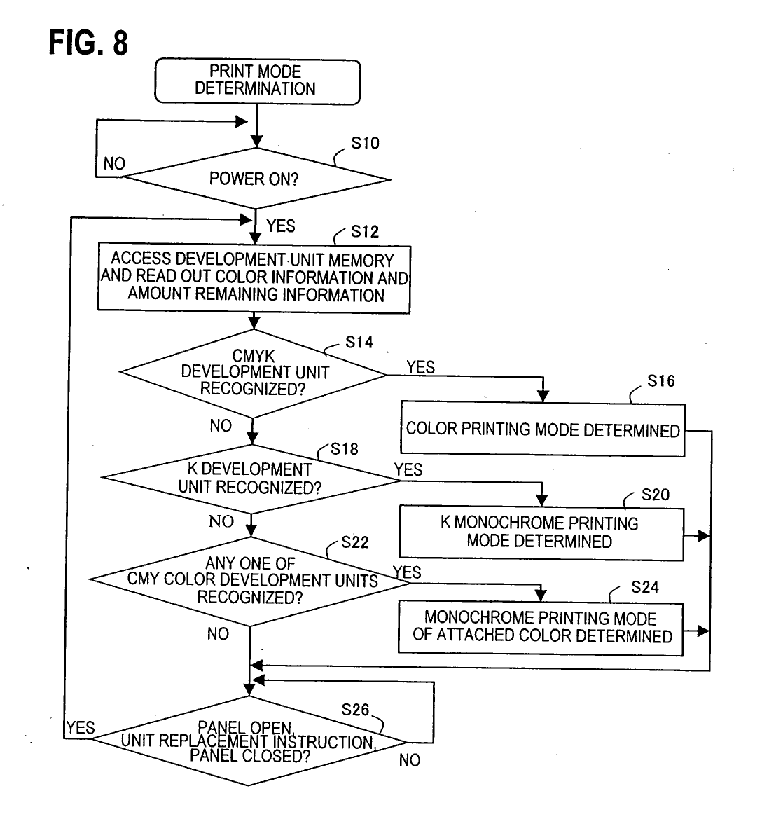

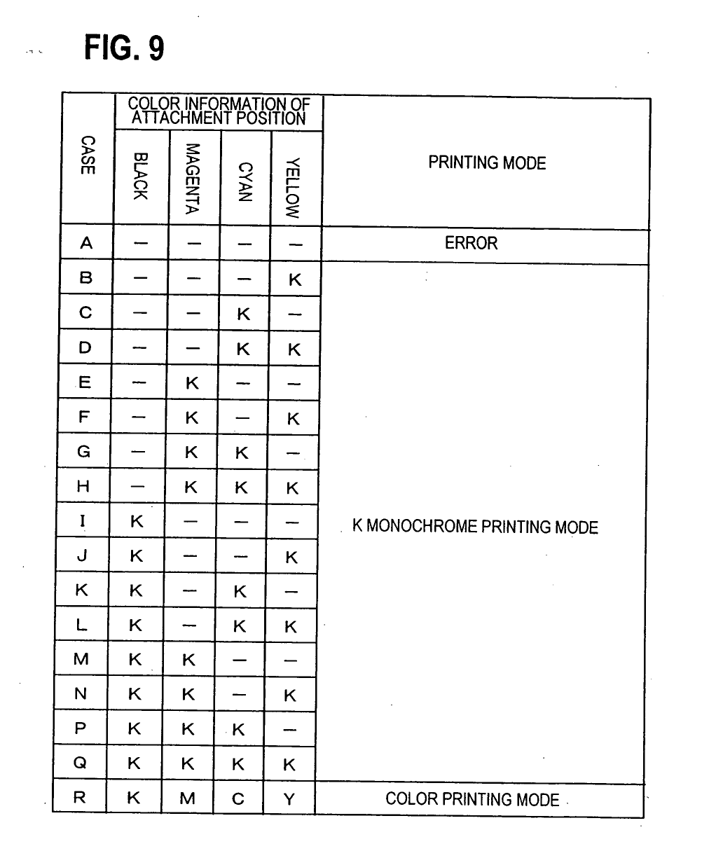

FIG. 8 is a flowchart indicating a print mode determination operation according to the present embodiment. FIG. 9 shows a determination table of the print mode determination. The determination table of FIG. 9 indicates whether or not any of the K, C, M, or Y development units is attached in the black, magenta, cyan, and yellow attachment positions. When the power is turned on (S10), the control unit 100, which is a control means of the printer 10, rotates the development device 50 to memory access positions, accesses the nonvolatile memories of the development units attached to the development device, and reads out (S12) identification information of the development unit, color information of the developing agent, initial total amount information, and amount remaining information. When the black K, magenta M, cyan C, and yellow Y development units are recognized as being attached in the four attachment positions (attachment positions for black, magenta, cyan, and yellow respectively) of the development device (S14), the main controller 101 of the control unit 100 determines color printing mode and writes that data to the nonvolatile memory 114a (S16). When the main controller 101 of the control unit recognizes that the four color development units are not attached but a black development unit is attached in any of the four attachment positions (S18), the black monochrome printing mode is determined and writes that data to the nonvolatile memory 114a (S20).

The determinations up to here are as shown in the determination table of FIG. 9. That is, only the predetermined color CMY development units can attach in the four attachment positions and therefore when color printing mode is determined (case R in FIG. 9), the CMYK development units are attached in the predetermined rotation direction order. Consequently, in the four times of development processing in color printing mode, the four development units of the development device 50 may be made to rotate in order and approach the photosensitive drum 20 to enable high speed printing with high image quality. When the CMYK development units can be attached in arbitrary positions, it is necessary to make the CMYK development units approach the photosensitive drum while shifting the development device back and forth in the rotation direction to achieve development in the CMYK order for high image quality, which involves complicated rotational control and poses a risk of reduced development speed.

On the other hand, black monochrome printing mode (cases B to Q in FIG. 9) is determined regardless of how many and in which attachment positions the black development units are attached. That is, there is no restriction concerning the attachment positions for the black development unit and consequently the user is allowed to attach an arbitrary number of black development units in arbitrary positions, which enables increased convenience.

Furthermore, when only one of any of the CMY color development units is recognized as being attached (S22), monochrome printing mode in the developing agent color of the development unit that is attached is determined (S24). In this case, since the CMY development units can be attached in only predetermined attachment positions, there is a condition that only one development unit is attached.

When the user, in response to a toner finished display or at a desired timing, opens the development unit replacement panel, gives an instruction for unit replacement by pushing the development unit replacement button, and closes the replacement panel after replacement of the development unit (S26), the control unit 100 executes the determination operation of the above-described steps S12 to S24.

It should be noted that in FIG. 7, if the above-described convex portions are not provided in the CMY development units other than black, an arbitrary number of development units can be attached in arbitrary positions of development roller. In the case of such a configuration, a plurality of any of the CMY development units other than black can be attached to carry out monochrome printing mode.

Furthermore, although not listed in the determination table of FIG. 9, when the CMYK development units are not attached, and also when any of the CMY development units is attached in addition to a plurality of the black development units, black monochrome printing mode may be determined. In this case, the above-described information is read out from the memories of the black development units that are attached and the display panel 95 is controlled to display the initial total amount information and the amount remaining information.

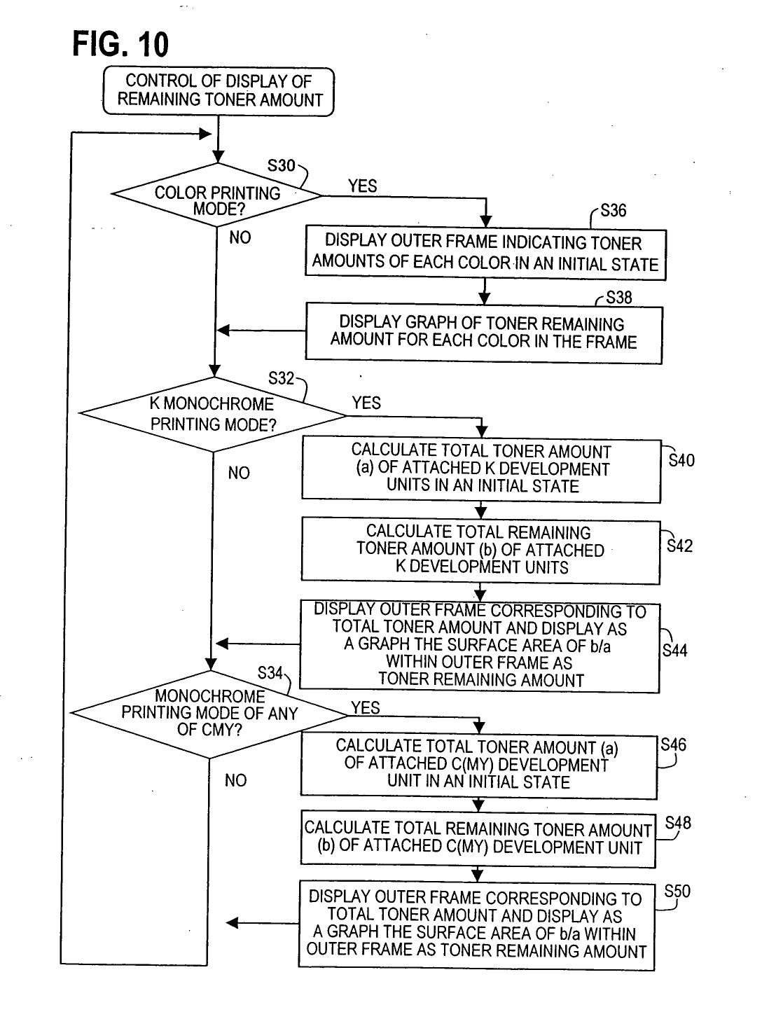

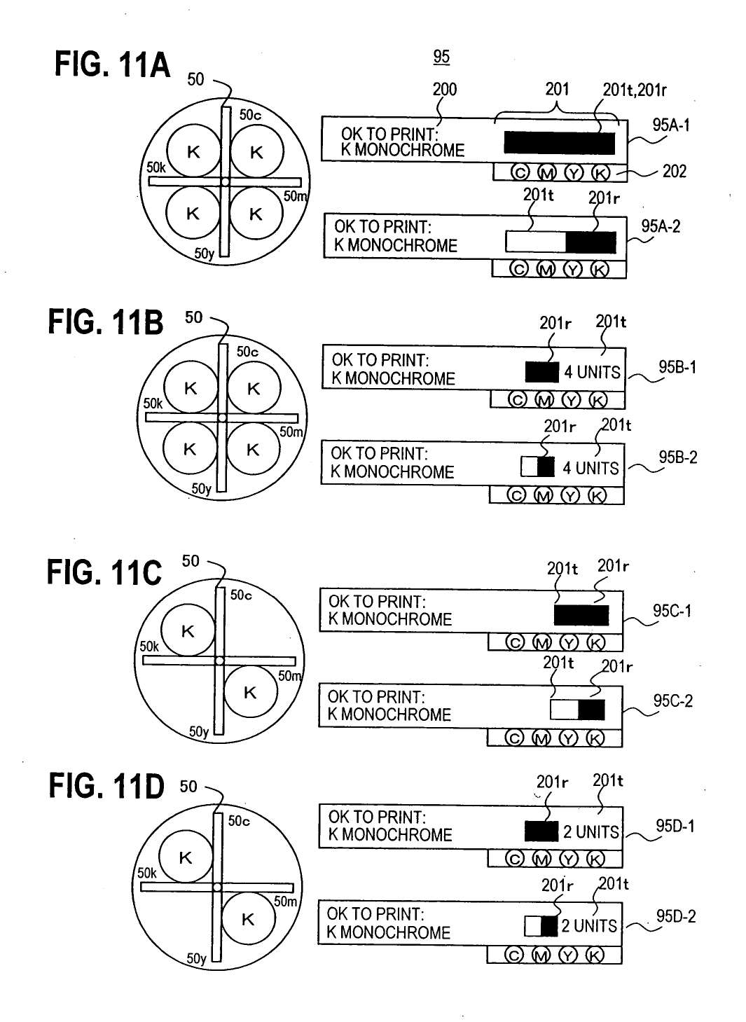

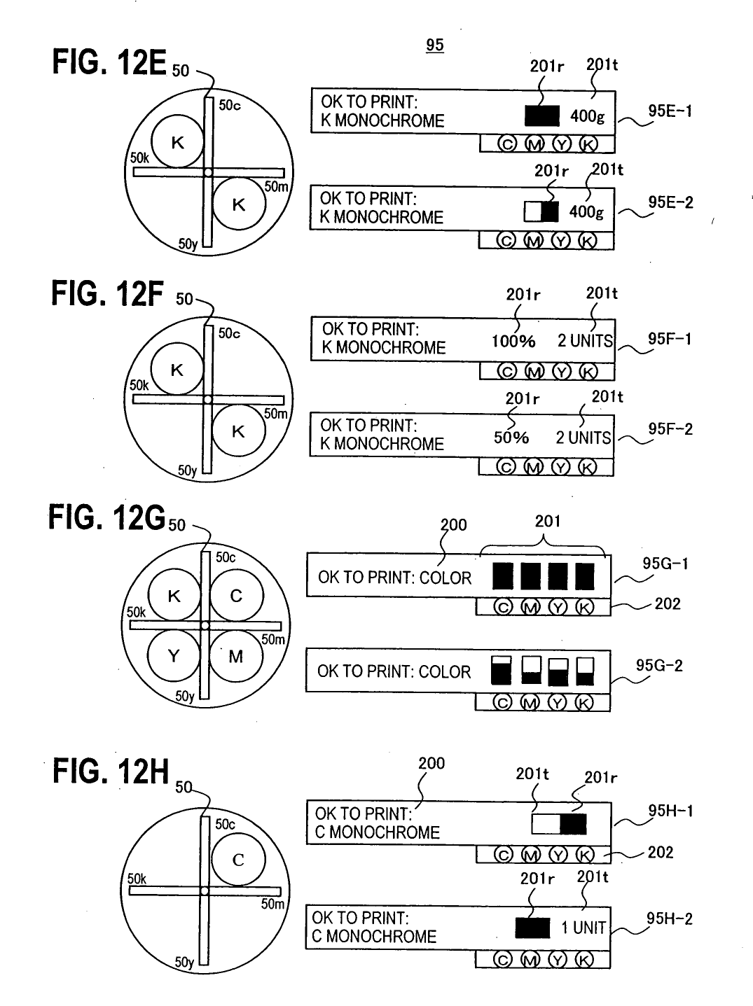

FIG. 10 is a flowchart showing an operation of controlling display of an amount of remaining toner. Furthermore, FIG. 11 illustrates development unit attachment conditions and examples of display on the display panel in black monochrome printing mode. Further still, FIG. 12 shows examples of display on the display panel in monochrome printing mode and color printing mode.

In black monochrome printing mode, an arbitrary number of the development units are permitted to be attached in the four attachment positions. Furthermore, in monochrome printing mode it is possible to select integrated usage, in which for example a plurality of attached development units are used equally or in order and development unit replacement is carried out when the developing agent remaining amount of all the development units becomes zero, and individual usage, in which a development unit having a prescribed attribute is used according to the attributes of the plurality of attached development units, and replacement of development units is also carried out individually.

In the case of the above-mentioned integrated usage, it is required that the user observes the overall toner remaining amount and not the separate toner remaining amounts of each attached development unit, and carries out and administration of development unit replacement. In particular, when using a plurality of development units equally, the aggregate remaining amount is more effective than displaying the remaining amount of individual development units. Accordingly, in the present embodiment, information of the total toner amount in an initial state of the attached development units and information of the current toner remaining amount is displayed so as to be useful in controlling the development units in monochrome printing mode.

FIGS. 11A and 11B show examples of display on the display panel 95 in monochrome printing mode in which four black development units are attached. In FIG. 11A, a display 200 of black (K) monochrome printing mode and a display 201 of the total toner amount (initial total amount information) in an initial state of the four development units and the current total remaining amount of toner (amount remaining information) are displayed on the display panel 95. In display example 95A-1, the total amount of toner in an initial state and the current toner remaining amount are equivalent, and therefore an initial total amount display 201t and a total remaining amount display 201r are displayed overlapping in the remaining amount display 201. That is, this indicates that the total remaining amount is 100%. On the other hand, in display example 95A-2, the initial total amount display 201t is displayed by a horizontally long white frame and the total remaining amount display 201r is displayed as a horizontally long bar graph. That is, the horizontal direction length of the initial total amount display 201t and the total remaining amount display 201r correspond to the respective amounts. In other words, this indicates that the total remaining amount is 50%. In the example above, the initial total amount is indicated by its lateral length and the total remaining amount is also indicated by its lateral length such that the proportion of the total remaining amount to the initial total amount is evident.

In FIG. 11B, the initial total amount is displayed by a text display 201t that indicates the number of attached development units. Then, the total remaining amount is shown by a black bar graph 201r that indicates the total remaining amount with respect to a white frame that indicates the initial total amount so that the proportion of the total remaining amount to the initial total amount is evident. In FIG. 11B, the attachment condition of the development units is the same as in FIG. 11A, but in the display example 95B-1, shown are the initial total amount display 201t by text and the total remaining amount display 201r when the amount of toner remaining is 100%, while in the display example 95B-2, shown are the same displays 201t and 201r when the amount of toner remaining is 50%, which is a display of a different manner from the display examples 95A-1 and 95A-2.

FIGS. 11C and 11D show display examples of the display panel 95 in monochrome printing mode in which two black development units are attached. FIG. 11C is a display example of the same manner of display as FIG. 11A, and FIG. 11D is a display example of the same manner of display as FIG. 11B. In the case of FIG. 1C, the horizontal direction length of the initial total amount display 201t is half that of FIG. 11A. Accordingly, the fact that the total remaining amount 201r when the toner remaining amount is 100% in the display example 95C-1 is the same as the total remaining amount 201r when the toner remaining amount is 50% in the display example 95A-2 can be conveyed to the user. Further still, the user can be made to understand that the total remaining amount 201r when the toner remaining amount is 50% in the display example 95C-2 is half the total remaining amount 201r of the display example 95A-2. Furthermore, in the display examples 95D-1 and 95D-2, the number of development units “2 UNITS” is displayed in text as the initial total amount display 201t.

FIGS. 12E and 12F show different display examples of the display panel 95 in monochrome printing mode in which two black development units are attached. In FIG. 12E, the initial total amount display 201t is shown by the toner weight (absolute quantity) with the text “400 g.” The total remaining amount display 201r is shown by a bar graph in a white frame so that the proportion of the total remaining amount to the initial total amount is evident as in FIG. 12D. This example is effective when the initial state of the development units is not limited to a state in which the development units contain a full container of developing agent. That is, when the development unit is filled to only a quarter with developing agent such as for a free sample, the initial total amount is displayed by the weight of the toner for example and the absolute quantity thereof can be grasped accurately. As a different display example, the initial total amount may be displayed as an estimated number of sheets that can be printed.

Furthermore, in FIG. 12F, the initial total amount display 201t is shown by the number of development units with the text “2 UNITS,” and the total remaining amount display 201r is also shown as a proportion of the initial total amount with the text “100%” and “50%.” Further still, the initial total amount display 201t may be displayed with the text “400 g.”

FIG. 12G shows color printing mode in which the CMYK development units are attached in the four CMYK attachment positions. In this case, the display panel 95 displays that the display 200 indicating color printing mode and a remaining amount display 201 in which the respective color development units are shown individually for the CMYK attachment position display 202. The display example 95G-1 indicates that the remaining amount in all the development units is 100% and the display example 95G-2 indicates that the remaining amount in the respective development units is not 100%. Here also the white frame indicates the initial total amount and the bar graph indicates the remaining amount. However, the length in the vertical direction rather than the horizontal direction corresponds to the respective amounts.

FIG. 12H shows a monochrome printing mode in which the cyan development unit is attached in only the cyan attachment position 50c. In this case, the display panel 95 displays the display 200 indicating the cyan monochrome printing mode, the initial total amount display 201t, and the total remaining amount display 201r. In the display example 95H-1, the initial total amount display 201t is indicated by a horizontally long white frame and the total remaining amount display 201r is indicated by a bar graph. Furthermore, in the display example 95H-2, the initial total amount display 201t is indicated by the text “1 UNIT,” and the total remaining amount display 201r is shown as a bar graph inside the white frame to indicate the total remaining amount with respect to the initial total amount. The initial total amount display 201t may be displayed as an absolute quantity such as the toner weight with “100 g” for example.

Next, other display examples are described of when four black development units are attached as in FIG. 11A and of when two black development units are attached as in FIG. 11C. In these cases, the initial total amount corresponding to each of the attachment positions is displayed by a white frame as in the display example of FIG. 12G. Since the initial total amounts of the development units are usually the same, the white frames are all the same size. In the case of FIG. 11A, four white frames are displayed in the CMYK positions and in the case of FIG. 11C, two white frames are displayed in the MK positions. Then, an average value of the remaining amount of developing agent in all the development units is displayed as a black bar graph inside the white frames. That is, the same average value is displayed in all the white frames. By doing this, the attachment position of the development unit and the total remaining amount can be grasped easily.

Returning to the flowchart of FIG. 10 of controlling the display of the remaining amount of toner, when the CPU 111 of the main controller 101 determines color printing mode (S30), it displays an outer frame indicating the amount of toner in an initial state for each color of CMYK (S36) and then displays the remaining amount of toner for each color as a bar graph in the frames (S38). This form of display is as shown by the display examples 95G-1 and 95G-2 in FIG. 12. When black monochrome printing mode is determined (S32), the CPU 111 obtains various information from the memories of the attached development units and determines (S40) an initial total amount a, which is the total amount of toner in an initial state, then further determines (S42) a total remaining amount b, which is the current amount of remaining toner. Then, an outer frame of a size corresponding to the initial total amount a is displayed and a bar graph of a size corresponding to a remaining amount proportion b/a is displayed (S44) as remaining amount information in the outer frame thereof. The initial total amount a may be displayed in such ways as in text as the number of development units or an absolute quantity of toner, or a number of sheets that can be printed. These display examples are as shown in FIG. 11 and FIGS. 12E and 12F. Further still, when the CPU 111 determines monochrome printing mode using any one of CMY, the initial total amount a is calculated (S46), the total remaining amount b is calculated (S48), and the proportion b/a of the initial total amount a and the remaining amount b is displayed (S50) for the development unit of the determined color.

As described above, with the present embodiment, a display of the initial total amount of a plurality of attached development units and a display of a total remaining amount are carried out in monochrome printing mode. This form of display is particularly effective in a usage mode in which for example a plurality of black development units are attached and all the development units are used without being differentiated and replaced when the remaining amount of all the development units becomes zero. In the case of carrying out development processing using four development units equally to make uniform the balance of the development rotary with respect to the black development units that are attached in the four attachment positions of the development device, it is evident that it is more effective to display the initial total amount and the total remaining amount as described above than to display the initial total amounts and the remaining amounts of the four development units separately. On the other hand, for color printing mode, since it is necessary to control replacements of development units separately, it is effective to display the proportion of the remaining amount of each color corresponding to an initial value and corresponding to the attachment positions.

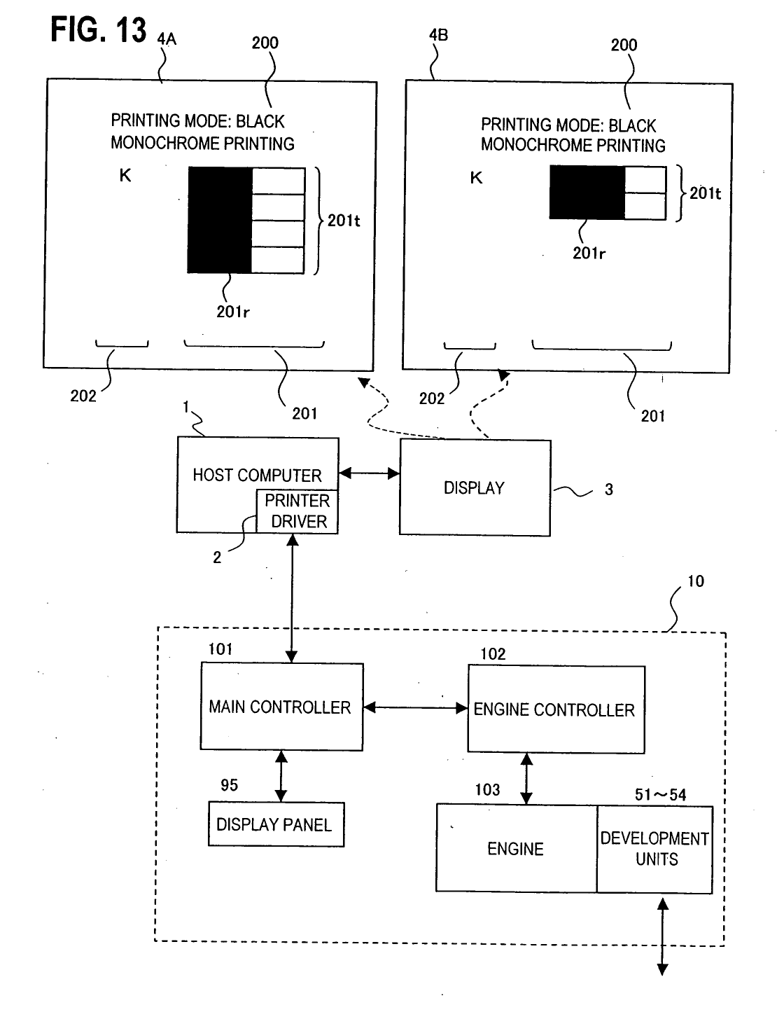

FIG. 13 illustrates examples of displaying the amount of remaining toner in the development units by a printer driver of a host computer. A host computer 1 is communicably connected to the printer 10 either directly or via a network by a cable or wirelessly and the initial total amounts and the total remaining amounts are displayable on the display 3 using a printer driver 2 that is installed in the host computer 1.

At a time such as when powering on, the main controller 101 obtains color information, initial toner amount information, and toner remaining amount information of the development units 51 to 54 inside an engine 103 via an engine controller 102 and, in the case of monochrome printing mode, determines the initial total amount and the total remaining amount and notifies to the printer driver 2 data of which color is to be used for monochrome printing mode, the initial total amount, and the total remaining amount. Furthermore, after this, when the attachment condition of the development units is changed or when the information of the amount of toner remaining is updated, these items of information are notified to the printer driver.

When four black development units are attached, the printer driver 2 displays the display 200 indicating the black monochrome printing mode and displays the outer frame 201t having a vertical direction length corresponding to the initial total amount and the bar graph 201r having a horizontal direction length corresponding to the total remaining amount as the remaining amount display 201 as shown in the display example 4A. Furthermore, when two black development units are attached, the printer driver 2 displays the outer frame 201t having a vertical direction length corresponding to the initial total amount and the bar graph 201r having a horizontal direction length corresponding to the total remaining amount as the remaining amount display 201 as shown in the display example 4B. The vertical direction length of the outer frame 201t in the display example 4B is half the vertical direction length of the outer frame 201t in the display example 4A.

In addition to the display examples 4A and 4B that are shown in FIG. 13, it is also possible to display the initial total amount using text and to display the total remaining amount as a proportion of the initial total amount as shown in FIGS. 11 and 12.

The user is able to recognize the initial total amount and the total remaining amount of the developing agent on a monitor screen 3 of the host computer 1 as in the illustrative images 4A and 4B such that convenience for controlling replacements and additions of development units can be improved.

Furthermore, the display in color printing mode is the same as the display of the display panel described in FIG. 12.

### INDUSTRIAL APPLICABILITY

The present invention provides display having convenience for a user and simplifies control of development units when displaying the amount of remaining developing agent in an image forming device such as a printer.

1. An image forming device, comprising:
an image carrier on which a latent image is formed; and
a development device in which a plurality of development units housing developing agent are detachably attached, wherein
the image forming device operates in a monochrome printing mode when an arbitrary number of same color development units are attached at a plurality of attachment positions of the development device, and
further comprising:
a display unit which displays a remaining amount of developing agent in the development units; and
a control unit which obtains an initial total amount of developing agent in an initial state and a current total remaining amount of developing agent of the attached development units, and displays on the display unit information of the initial total amount and information of the total remaining amount.

2. The image forming device according to claim 1,
wherein information of the total remaining amount is remaining amount information that indicates a proportion of the total remaining amount with respect to the initial total amount.

3. The image forming device according to claim 1,
wherein the control unit displays, on the display unit, an outer frame display of a size corresponding to the initial total amount and a remaining amount display of a size corresponding to the total remaining amount in parallel.

4. The image forming device according to claim 1,
wherein the control unit displays, on the display unit, a character display corresponding to the initial total amount and a remaining amount display indicating a proportion of the total remaining amount with respect to the initial total amount in parallel.

5. The image forming device according to claim 1,
wherein the image forming device performs an operation in color printing mode when a plurality of color development units are attached in the attachment positions of the development device, and
the control unit causes the display unit to display distinctly the color printing mode and monochrome printing mode based on obtained color information.

6. The image forming device according to claim 1,
wherein the control unit outputs, as appropriate, data of the initial total amount and data of the total remaining amount to a host computer that is communicably provided to the image forming device, and causes the host computer to display, information of the initial total amount and information of the total remaining amount.

7. An image forming device, comprising:
an image carrier on which a latent image is formed; and
a development device in which a plurality of development units housing developing agent are detachably attached, and the image forming device being able to communicate with a host computer, wherein
the image forming device operates in a monochrome printing mode when an arbitrary number of same color development units are attached at a plurality of attachment positions of the development device, and obtains an initial total amount of developing agent in an initial state and a current total remaining amount of developing agent of the attached plurality of development units, and outputs, as appropriate, to the host computer data of information of the initial total amount and information of the total remaining amount, and causes the host computer to display the information of the initial total amount and the information of the total remaining amount.

8. The image forming device according to claim 7,
wherein the information of the total remaining amount is remaining amount information that indicates a proportion of the total remaining amount with respect to the initial total amount.
